(19) United States
(12) Patent Application Publication
(10) Pub. No.: US 2026/0097548 A1
(43) Pub. Date: Apr. 9, 2026

(54) CLAMPING UNIT FOR A MOLDING MACHINE

(71) Applicant: ENGEL AUSTRIA GmbH, Schwertberg (AT)

(72) Inventors: Christoph BALKA-HINTERSTEINER, Schwertberg (AT); Gerhard HACKL-LEHNER, St. Thomas/BI. (AT)

(21) Appl. No.: 19/345,651

(22) Filed: Sep. 30, 2025

(30) Foreign Application Priority Data
Oct. 3, 2024 (AT) A 50803/2024

(51) Int. Cl. B29C 45/68

(52) U.S. Cl. CPC B29C 45/68; B29C 2045/685

(57) ABSTRACT

A clamping unit includes a fixed mold mounting plate and a movable mold mounting plate mounted movably relative to the fixed mold mounting plate along a longitudinal axis. The movable mold mounting plate and the fixed mold mounting plate are mounted on a frame, and the frame is arranged on a lateral frame-side plate side of the movable mold mounting plate and the fixed mold mounting plate. The fixed mold mounting plate is fixedly connected to the frame of the clamping unit in a first fastening area positioned on the frame-side plate side of the fixed mold clamping plate. The fixed mold clamping plate is connected to the frame of the clamping unit in a second fastening area positioned on a second side of the fixed mold clamping plate facing away from the frame-side plate side, by an actuator.

### BACKGROUND OF THE INVENTION

The present invention relates to a clamping unit for a molding machine, as well as a molding machine having such a clamping unit.

Molding machines can be understood to mean injection molding machines, injection presses, presses, and the like. Molding machines in which the plasticized molding compound is fed into an open molding tool are also conceivable.

The state of the art will be outlined below using an injection molding machine as an example. The same applies in general to molding machines.

Well-known designs of clamping units for molding machines usually comprise a fixed mold clamping plate and a movable mold clamping plate that can be moved relative to it. Mold tool parts of a mold tool are arranged on these mold clamping plates, which in a closed state form a mold cavity into which a plasticized plastic can be injected to produce a molded part.

In order to operate the injection molding process, the clamping unit has two tasks to perform.

On the one hand, by a relative movement of the movable mold clamping plate relative to the fixed mold clamping plate, the mold tool parts of the mold tool are moved apart and together, whereby after injection molding, a molded part can be released for removal and/or an insert can be inserted into the mold tool for overmolding or injection molding. This function of moving the movable mold clamping plate relative to the fixed mold clamping plate is performed by the rapid stroke device.

On the other hand, the clamping unit must generate a clamping force that holds the mold tool parts of the mold tool together during the actual injection molding process and thus counteracts the injection pressure of the injected plastic, whereby significantly higher forces occur than with the fast-acting device.

This clamping force is usually generated by a clamping force mechanism, which presses the movable mold clamping plate toward the fixed mold clamping plate, thereby exerting a compressive force-a clamping force-on the mold tool located between them.

In known embodiments of the prior art—in particular in so-called tie-bar-less clamping units and/or clamping units with C-frames—it is common practice to connect a fixed mold clamping plate fixedly to a frame of the clamping unit, whereas the movable mold clamping plate is mounted on the frame in a movable manner relative to the fixed mold clamping plate via a guide. To move and/or build up the clamping force of the movable mold clamping plate, a corresponding actuator is usually attached to the movable mold clamping plate, which is supported on the frame of the clamping unit.

However, the problem with such designs is that the high pressures and forces during the injection molding process, which often act asymmetrically to a central longitudinal axis of the clamping unit, can cause one-sided gapping or deviation from the usually desired parallel arrangement of the mold clamping plates.

However, parallelism of the mold clamping plates ensures that a mold cavity of the mold tool is closed at a parting line during the injection molding process on the one hand, and that the desired geometric shape of the mold cavity is formed on the other hand.

If such parallelism cannot be guaranteed, the quality of the molded part to be produced will suffer, or even lead to the production of scrap parts.

Thus, a wide variety of state-of-the-art designs are known for ensuring the necessary parallelism of the mold clamping plates, most of which describe an adjustment of the relative position of the movable mold clamping plate to the fixed mold clamping plate in order to maintain parallelism during the injection molding process.

Variants of the prior art are also known in which the relative position of the fixed mold clamping plate can be adjusted relative to the movable mold clamping plate, whereby in most cases the fixed mold clamping plate can be tilted on one side by means of actuating elements in order to adjust the relative tilt relative to the movable mold clamping plate.

For example, DE 197 32 337 A1 discloses a method of using a pressure bar to allow slight tilting of the fixed mold clamping plate under the influence of clamping force. However, the disadvantage of this method is that this tilting is inevitably dependent on the clamping force and cannot be actively adjusted to address other aspects.

DE 10 2014 005923 A1 discloses mounting the fixed mold clamping plate on the frame by means of a temperature-controlled actuator, whereby this actuator can be influenced in its expansion by heating or cooling, thereby enabling relative tilting of the mold clamping plate relative to the frame. However, this option also represents a rather limited and time-delayed possibility for influencing the parallelism of the plates. The temperature of an actuator can only be adjusted under a certain time influence. With the ever-increasing cycle times of injection molding machines, however, the time component for control or regulation is a decisive factor.

### SUMMARY OF THE INVENTION

The task is to provide a clamping unit for a molding machine as well as a molding machine comprising such a clamping unit, with which the aforementioned disadvantages of the prior art can be at least partially improved and/or mold clamping plate parallelism can be implemented more quickly or individually and/or which represents a low-cost or low-effort alternative for influencing mold clamping plate parallelism.

This task is solved by a clamping unit as described below, as well as a molding machine with such a clamping unit.

A clamping unit for a molding machine according to an embodiment comprises a fixed mold mounting plate and a movable mold mounting plate mounted movably along a longitudinal axis relative to the fixed mold mounting plate. The movable mold mounting plate and the fixed mold mounting plate are mounted on a frame, and the frame is arranged on a lateral frame-side plate side of the movable mold mounting plate and the fixed mold mounting plate. The fixed mold mounting plate:
is fixedly connected to a frame of the clamping unit in a first fastening area, which first fastening area is positioned on the frame-side plate side of the fixed mold clamping plate, and
is connected to the frame of the clamping unit by means of at least one actuator in a second fastening area, which is positioned on a second side of the fixed mold clamping plate facing away from the frame-side plate side.

Since the fixed mold clamping plate is fixedly connected to the frame in a first fastening area and is arranged on the frame via an actuator in the second fastening area, a force can be exerted on the fixed mold clamping plate via the actuator, resulting in elastic deformation and/or tilting of the fixed mold clamping plate around the first fastening area.

Since this first fastening area is positioned closer to the frame side of the fixed mold clamping plate than the second fastening area—i.e., the fixed connection of the fixed mold clamping plate is closer to the frame than the connection of the fixed mold clamping plate via the actuator to the frame is intended—the fixed mold clamping plate can be moved by actuating the actuator, in particular against a frame deformation of a C-frame.

By providing an actuator, a force can also be applied to the fixed mold clamping plate in a targeted manner, thereby deforming the fixed mold clamping plate independently of any clamping force.

This has the significant advantage that deformation of the clamping unit can be counteracted in a simple, fast, and targeted manner by controlling or regulating the actuator accordingly. In other words, in preferred embodiments, bending of the legs of a C-frame can be compensated for.

It should be noted that in certain special applications, a slight relative misalignment of the fixed mold clamping plate to the movable mold clamping plate is desirable, for example, because asymmetrical molded parts are to be produced. In order to compensate for an asymmetrical buoyancy force of the molded material in the mold, a slight misalignment of the mold clamping plates can be advantageous. In addition to the advantages mentioned, a corresponding embodiment can also achieve a desired skewing more precisely and accurately.

In the context of this document, when referring to a plate, it is not necessarily assumed that this is a flat, even plate. It may also feature recesses, elevations, and concave machining for the clamping surface to ensure optimum distribution of clamping force when closed. Designs with ribs, webs, or other structures for stabilization or deformation optimization are also conceivable.

Molding machines can be understood to mean injection molding machines, injection presses, presses, and the like. Molding machines in which the plasticized molding compound is fed into an open molding tool are also conceivable.

It is entirely conceivable that a clamping unit according to the present disclosure could be used in existing state-of-the-art systems—as described in the introduction to the description, for example—and could, so to speak, be retrofitted to existing systems.

Within the scope of a clamping unit described in the present disclosure, this may be a horizontal clamping unit (in which the relative movement of the movable mold clamping plate with respect to the fixed mold clamping plate takes place along a direction of movement that is at least largely horizontal) or a vertical clamping unit (in which the relative movement of the movable mold clamping plate with respect to the fixed mold clamping plate takes place along a direction of movement that is at least largely vertical).

In one embodiment of a horizontal clamping unit, the fixed mold clamping plate:
is fixedly connected to a frame of the clamping unit in a lower, first fastening area, and
is connected to the frame of the clamping unit in a second fastening area above the first fastening area by means of at least one actuator.

Furthermore, protection is sought for a molding machine with a clamping unit according to an embodiment of the present invention.

The at least one actuator may be designed as a hydraulic piston-cylinder unit and/or as a piezo actuator. Other embodiments of an actuator with which high forces can be applied at low actuator strokes are also conceivable.

Preferably, at least one recess, in particular a blind hole or a bore, is provided in the frame and/or the fixed mold clamping plate of the clamping unit in the second fastening area, which at least one recess is designed to accommodate the at least one actuator and/or as part of the at least one actuator, preferably as a cylinder of a piston-cylinder unit.

The fixed mold clamping plate may be connected to the frame in the first fastening area by a screw connection and/or a material-bonded connection.

The fixed mold clamping plate in the first fastening area and/or the frame adjacent to the first fastening area preferably comprises at least one joint, preferably a flexure joint, which at least one joint allows or facilitates tilting of the fixed mold clamping plate.

A flexure joint can be formed, for example, by a geometric design with a constriction in cross-section, which allows the elastic deformation to be controlled.

The flexure joint may be formed by the screw connection between the fixed molding clamping plate and the frame in the first fastening area, whereby deformation of the screw connection (in particular elastic elongation of the screws due to tensile stress) allows movement of the flexure joint.

The first fastening area comprises at least two sub-regions, in particular wherein the at least two sub-regions of the first fastening area are positioned substantially horizontally relative to each other on the fixed mold clamping plate. For example, a control or regulating device may be provided which is designed to control or regulate the parallelism of the plates while a clamping force is applied to the clamping unit, preferably by controlling or regulating the at least one actuator.

Preferably, the movable mold clamping plate is connected to a clamping force mechanism which is designed to build up a clamping force via the movable mold clamping plate between the movable mold clamping plate and the fixed mold clamping plate.

The frame of the clamping unit can be designed as a C-frame, to which the movable mold clamping plate is mounted movably supported along the longitudinal axis by means of a guide.

A guide between the movable mold clamping plate and the frame may comprise, for example, at least one slide guide and/or at least one roller guide.

Preferably, the clamping unit may be designed as a tie-bar-less clamping unit and/or a 2-plate clamping unit.

### BRIEF DESCRIPTION OF THE DRAWINGS

Further details and advantages will be explained in more detail below with reference to the drawings, in which:

FIG. 1 shows a first embodiment of a clamping unit, and

FIG. 2 is a sectional view A-A indicated in FIG. 1.

### DETAILED DESCRIPTION OF THE INVENTION

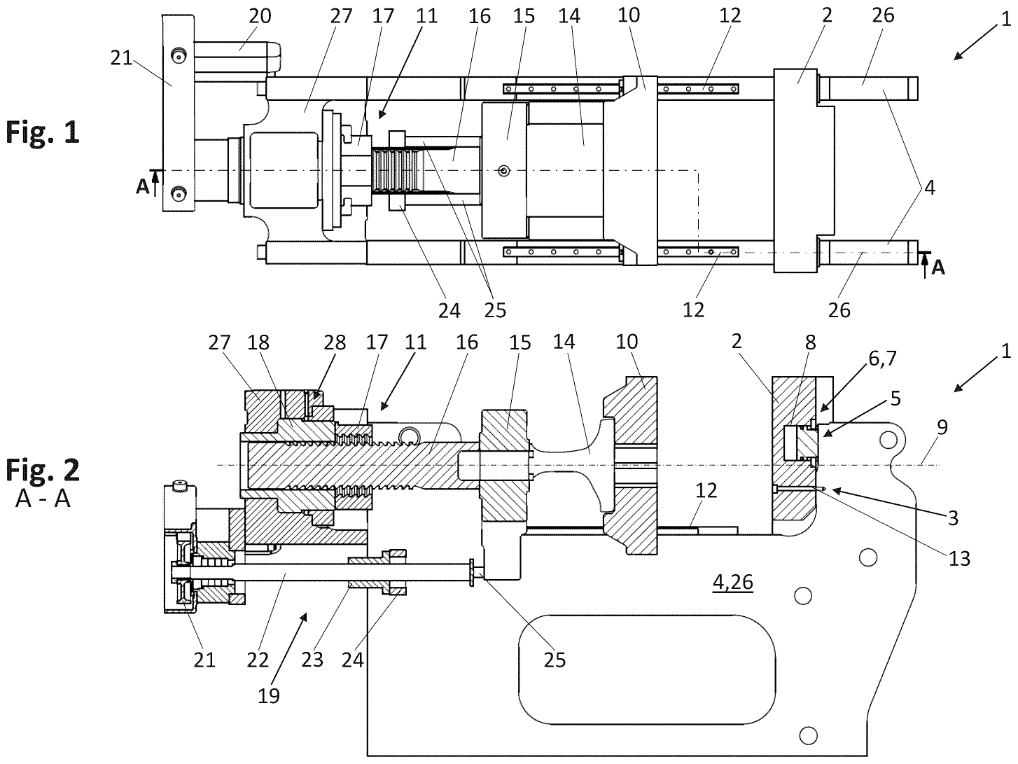

FIGS. 1 and 2 show a first embodiment of a clamping unit 1.

FIG. 1 shows a top view of the clamping unit 1, and FIG. 2 shows a side view with the section A-A indicated in FIG. 1.

The clamping unit 1 comprises a two-part frame 4, which has a left and a right side panel 26.

The side panels 26 are connected to each other on one side by the fixed mold clamping plate 2 and on the other side by the bolted support plate 27. Furthermore, it may be provided that the clamping unit 1 comprises connecting bars which can connect the two side panels 26.

The clamping unit 1 has a fixed mold mounting plate 2 and a movable mold mounting plate 10 that is mounted so that it can be moved relative to the fixed mold mounting plate 2 along the longitudinal axis 9.

The movable mold clamping plate 10 is supported on the frame 4—more precisely, on the side walls 26 of the frame 4 via the slide guides 12—and can be moved along the longitudinal axis 9 by means of the rapid lifting device 19 via the drive plate 15 and the transmission body 14.

The rapid lifting device 19 comprises an electric drive unit 20, which is designed to perform an opening and/or closing movement of the movable mold clamping plate 10 by driving the spindle 22 of the spindle drive via the gearbox 21, whereby the recirculating ball nut 23 mounted on the spindle 22 can be moved linearly.

This ball screw nut 23 is in turn rigidly connected by a screw connection to the linkage bridge 24, which linkage bridge 24 in turn transmits the linear movement to the drive plate 15 via the linkage rods 25.

This rapid lifting device 19 allows a mold tool that can be arranged between the movable mold clamping plate 10 and the fixed mold clamping plate 2 to be opened and/or closed.

After a corresponding molding tool has been closed via the rapid lifting device 19, a clamping force can be exerted on the molding tool by means of the clamping force mechanism 11.

For this purpose, the pressure rod 16 connected to the drive plate 15 is connected to the piston 18 of the clamping force mechanism 11, which is designed as a piston-cylinder unit, by closing the split locking nut 17.

The piston 18 of the piston-cylinder unit 28 is mounted in a corresponding recess in the support plate 27, this recess forming the cylinder 18 of the piston-cylinder unit 28, whereby a corresponding pressure build-up of a hydraulic fluid between the support plate 27 and the piston 18 exerts a force via the pressure rod 16, the drive plate 15, the transmission body 14, and the movable mold clamping plate 10 onto a mold tool arranged between the movable mold clamping plate 10 and the fixed mold clamping plate 2 (the so-called clamping force).

Very high clamping forces cause deformation of the frame 4—more precisely, the side walls 26 of the frame 4—which leads to the C-shaped frame 4 gaping open and thus jeopardizes the parallelism of the movable mold clamping plate 10 to the fixed mold clamping plate 2.

However, in order to continue to provide plate parallelism between the movable mold clamping plate 10 and the fixed mold clamping plate 2, the movable mold clamping plate 10 is mounted in a tiltable manner via the transmission body 14.

In this embodiment, frame 4 is arranged on a lateral frame side plate side of the movable mold clamping plate 10 and the fixed mold clamping plate 2.

The fixed mold clamping plate 2 comprises a first fastening area 3 and a second fastening area 5.

The first fastening area 3 is positioned on the frame side of the fixed mold clamping plate.

The second fastening area 5 is positioned on a second side of the fixed mold clamping plate 2 facing away from the frame side of the plate.

Since the clamping unit 1 of this embodiment is designed as a horizontal clamping unit in a C-frame construction, the second fastening area 5 is arranged above the first fastening area 3.

In the first fastening area 3, the fixed mold clamping plate 2 is fixedly connected to the side walls 26 of the frame 4 by means of the screw connection 13.

In the second fastening area 5, the fixed mold clamping plate 2 is connected to the side walls 26 of the frame 4 via the actuator 6, whereby corresponding control or regulation of the actuator 6 enables the fixed mold clamping plate 2 to be tilted in order to control or regulate the parallelism of the fixed mold clamping plate 2 and the movable mold clamping plate 10.

In this embodiment, the actuator 6 is implemented as a hydraulic piston-cylinder unit 7.

The cylinder of the piston-cylinder unit 7 is represented by the fixed molding clamping plate 2 and a recess 8 in the plate itself, in which the piston of the piston-cylinder unit 7 is guided.

### REFERENCE LIST

1 Clamping unit
2 Fixed mold clamping plate
3 First fastening area
4 Clamping unit frame
5 Second fastening area
6 Actuator
7 Piston-cylinder unit
8 Recess
9 Longitudinal axis
10 Movable mold clamping plate
11 Clamping force mechanism
12 Sliding guide
13 Screw connection
14 Transmission body
15 Drive plate
16 Pressure rod
17 Split locking nut
18 Piston
19 Rapid lifting device
20 Electric drive unit
21 Gearbox
22 Spindle
23 Ball screw nut
24 Linkage bridge
25 Linkage rod
26 Side wall of the frame
27 Support plate
28 Piston-cylinder unit

1. A clamping unit for a molding machine, comprising:
a fixed mold clamping plate, and
a movable mold clamping plate movably mounted relative to the fixed mold clamping plate along a longitudinal axis,
wherein the movable mold clamping plate and the fixed mold clamping plate are mounted on a frame, and the frame is arranged on a lateral frame-side plate side of the movable mold mounting plate and the fixed mold mounting plate,
wherein the fixed mold mounting plate is fixedly connected to the frame of the clamping unit in a first fastening area, which first fastening area is positioned on the frame-side plate side of the fixed mold clamping plate, and
wherein the fixed mold clamping plate is connected to the frame of the clamping unit in a second fastening area, which is positioned on a second side of the fixed mold clamping plate facing away from the frame-side plate side, by at least one actuator.

2. The clamping unit according to claim 1, wherein the at least one actuator is designed as a hydraulic piston-cylinder unit and/or as a piezo actuator.

3. The clamping unit according to claim 1, wherein at least one recess, in particular a blind hole or a bore, is provided in the frame and/or the fixed mold clamping plate of the clamping unit in the second fastening area, which at least one recess is designed to accommodate the at least one actuator and/or as part of the at least one actuator, preferably as a cylinder of a piston-cylinder unit.

4. The clamping unit according to claim 1, wherein the fixed mold clamping plate is connected to the frame in the first fastening area by a screw connection and/or a material bonded connection.

5. The clamping unit according to claim 1, wherein the fixed mold clamping plate in the first fastening area and/or the frame, adjacent to the first fastening area, comprises at least one joint, preferably a flexure joint, which at least one joint allows the fixed mold clamping plate to tilt.

6. The clamping unit according to claim 1, wherein the first fastening area comprises at least two sub-regions, preferably wherein the at least two sub-regions of the first fastening area are positioned substantially horizontally to each other on the fixed mold clamping plate.

7. The clamping unit according to claim 1, wherein a plate parallelism of the fixed mold clamping plate and the movable mold clamping plate can be controlled or regulated by the at least one actuator.

8. The clamping unit according to claim 1, wherein a control or regulating device is provided which is designed to control or regulate the plate parallelism during the application of a clamping force to the clamping unit, preferably by controlling or regulating the at least one actuator.

9. The clamping unit according to claim 1, wherein the movable mold clamping plate is connected to a clamping force mechanism which is designed to build up a clamping force between the movable mold clamping plate and the fixed mold clamping plate.

10. The clamping unit according to claim 1, wherein the frame of the clamping unit is designed as a C-frame, to which the movable mold clamping plate is movably supported along the longitudinal axis by means of a guide.

11. The clamping unit according to claim 1, wherein the clamping unit is designed as a tie-bar-less clamping unit and/or a 2-platen clamping unit.

12. A molding machine, in particular injection molding machine, comprising at least one clamping unit according to claim 1.
